(19) United States
(12) Patent Application Publication
(10) Pub. No.: US 2012/0097465 A1
(43) Pub. Date: Apr. 26, 2012

(54) SYSTEM AND METHOD FOR CONTROLLING A SHUTTER IN A VEHICLE VIA A COOLING FAN DUTY-CYCLE

(75) Inventors: Michael G. Leffert, Howell, MI (US); Darren L. Bohne, Fraser, MI (US); David J. Liller, Plymouth, MI (US)

(73) Assignee: GM GLOBAL TECHNOLOGY OPERATIONS, INC., Detroit, MI (US)

(21) Appl. No.: 12/910,209

(22) Filed: Oct. 22, 2010

(51) Int. Cl. B60K 11/08

(52) U.S. Cl. 180/68.1

(57) ABSTRACT

A method is provided for controlling operation of an adjustable shutter configured to be operated between and inclusive of fully-closed and fully-opened positions for cooling a powertrain in a vehicle having a grille opening. The method includes monitoring operation of a fan capable of being driven at a selectable speed for cooling the powertrain. The method also includes maintaining the fully-closed position of the shutter when the speed of the fan is below a predetermined speed. The method additionally includes selecting a non fully-closed position of the shutter before the predetermined speed of the fan is selected. Furthermore, the method includes selecting the predetermined speed of the fan after the non fully-closed position of the shutter has been selected. A system for controlling operation of such a fan and a vehicle are also provided.

### TECHNICAL FIELD

The invention relates to a system and a method for controlling operation of a shutter in a vehicle via a duty-cycle of a cooling fan.

### BACKGROUND

Electrically as well as mechanically driven fans are frequently used in motor vehicles to draw ambient air through a vehicle grille in order to facilitate cooling of various vehicle systems and components. Additionally, shutters may be employed in motor vehicles to control and direct ambient air to further facilitate cooling of vehicle systems and components.

A shutter frequently consists of a frame and louvers or slats mounted within the frame. Louvers may be fixed, i.e., having a permanently set angle with respect to the frame. Louvers may also be operable, i.e., having an angle that is adjustable with respect to the frame for permitting a desired amount of air to pass from one side of the shutter to the other. Depending on the application and the construction of the frame, shutters can be mounted to fit within, or to overlap the opening.

### SUMMARY

A method is provided for controlling operation of an adjustable shutter configured to be operated between and inclusive of fully-closed and fully-opened positions for cooling a powertrain in a vehicle having a grille opening. The method includes monitoring operation of a fan capable of being driven at a selectable speed for cooling the powertrain. The method also includes maintaining the fully-closed position of the shutter when the speed of the fan is below a predetermined speed. The method additionally includes selecting a non fully-closed position of the shutter before the predetermined speed of the fan is selected. Furthermore, the method includes selecting the predetermined speed of the fan after the non fully-closed position of the shutter has been selected.

According to the method, the non fully-closed position of the shutter may be the fully-opened position. Furthermore, each of the acts of maintaining the fully-closed position of the shutter, selecting a non fully-closed position of the shutter, and selecting the predetermined speed of the fan may be accomplished by a controller.

The operation of the fan may be characterized by an established duty-cycle programmed into the controller. Accordingly, the predetermined speed of the fan may be selected based on the duty-cycle.

The powertrain may include an internal combustion engine, wherein the duty-cycle of the fan is established according to a load on the engine. The vehicle may include a heat exchanger and a fluid circulated through the heat exchanger such that the engine is cooled by the fluid and a sensor configured to sense a temperature of the fluid. In such a case, the duty-cycle of the fan may be additionally established according to the sensed temperature of the fluid.

According to the method, the shutter may be arranged one of integral to the grille opening and adjacent to the grille opening.

Additionally, the method may include monitoring the ambient temperature and selecting and locking a predetermined position of the shutter in response to the ambient temperature being below a predetermined value. Moreover, the method may include selecting one of an on state and an off state for the fan when the predetermined locked position of the shutter is selected.

A system for controlling operation of a fan and a vehicle that employs the above-described method for controlling operation of a fan are also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a partial side cross-sectional view of a vehicle having an adjustable shutter depicted in a fully-closed state;

FIG. 2 is a partial side cross-sectional view of a vehicle having the shutter shown in FIG. 1, with the shutter depicted in an intermediate state, which is an example of a non fully-closed state;

FIG. 3 is a partial side cross-sectional view of a vehicle having the shutter system shown in FIGS. 1 and 2, with the shutter depicted in a fully-opened state, which is another example of a non fully-closed state; and

FIG. 4 is a flow chart illustrating a method for controlling a flow of air through a grille opening in the vehicle via the adjustable shutter depicted in FIGS. 1-3.

### DETAILED DESCRIPTION

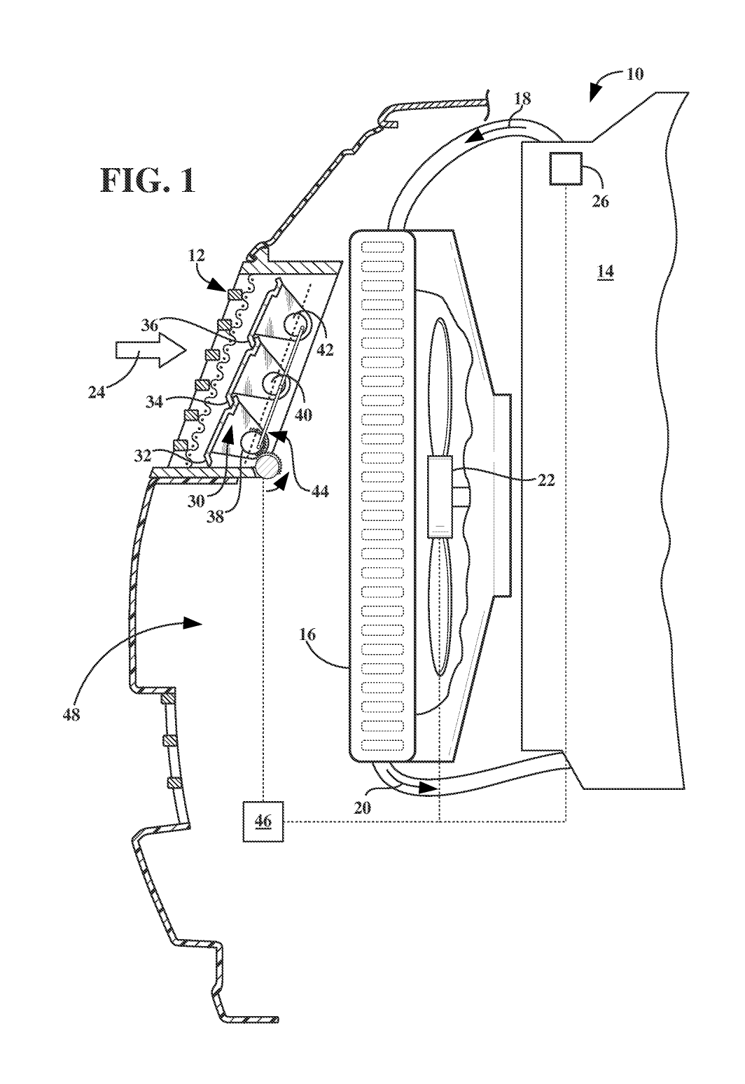

Referring to the drawings, wherein like reference numbers refer to like components, FIGS. 1-3 show a partial side view of a vehicle 10. The vehicle 10 is shown to include a grille opening 12 typically covered with a mesh. The grille opening 12 is adapted for receiving ambient air. The vehicle 10 additionally includes a powertrain that is specifically represented by an internal combustion engine 14. The powertrain of the vehicle 10 may additionally include a transmission, and, if the vehicle is a hybrid type, one or more motor-generators, none of which is shown, but the existence of which can be appreciated by those skilled in the art. Efficiency of a vehicle powertrain is generally influenced by its design, as well as by the various loads the powertrain sees during its operation.

The vehicle 10 additionally includes an air-to-fluid heat exchanger 16, i.e., a radiator, for circulating a cooling fluid shown by arrows 18 and 20, such as water or a specially formulated coolant, though the engine 14 to remove heat from the engine. A high-temperature coolant entering the heat exchanger 16 is represented by the arrow 18, and a reduced-temperature coolant being returned to the engine is represented by the arrow 20. The heat exchanger 16 is positioned behind the grille opening 12 for protection of the heat exchanger from various road-, and air-borne debris. The heat exchanger 16 may also be positioned in any other location, such as behind a passenger compartment, if, for example, the vehicle has a rear or a mid-engine configuration, as understood by those skilled in the art.

As shown in FIGS. 1-3, a fan 22 is positioned in the vehicle 10, behind the heat exchanger 16, such that the heat exchanger 16 is positioned between the grille opening 12 and the fan. The fan 22 is capable of being selectively turned on and off based on the cooling needs of the engine 14. Depending on the road speed of the vehicle 10, the fan 22 is adapted to either generate or enhance a stream of air or airflow 24 through the grille opening 12, and toward and through the heat exchanger 16. Thus generated or enhanced through the action of the fan 22, the airflow 24 is passed through the heat exchanger 16 to remove heat from the high-temperature coolant 18 before the reduced-temperature coolant 20 is returned to the engine 14. The fan 22 may be driven either electrically, or mechanically, directly by engine 14. The vehicle 10 additionally includes a coolant sensor 26 configured to sense a temperature of the high-temperature coolant 18 as it exits the engine 14.

Because the fan 22 is driven by the engine 14, size of the fan is typically selected based on the smallest fan that in combination with the available grille opening 12 is sufficient to cool the engine during severe or high load conditions imposed on the vehicle 10. Typically, however, when the size of the grille opening 12 is tailored to such severe load conditions, the grille opening generates significant aerodynamic drag on the vehicle which causes a loss in operating efficiency of the engine 14. On the other hand, if the size of the grille opening 12 is chosen based on the aerodynamic and operating efficiency requirements at higher vehicle speeds, the size of the fan 22 that is required to generate sufficient airflow at high load conditions becomes so great, that the fan generates significant parasitic drag on the engine 14. Therefore, an adjustable or variable size for the grille opening 12 would permit the fan 22 to be sized for minimum parasitic drag on the engine 14, while being capable of satisfying the high vehicle load cooling requirements. At the same time, such an adjustable grille opening 12 would permit selection of a smaller fan that would further serve to increase the operating efficiency of the powertrain.

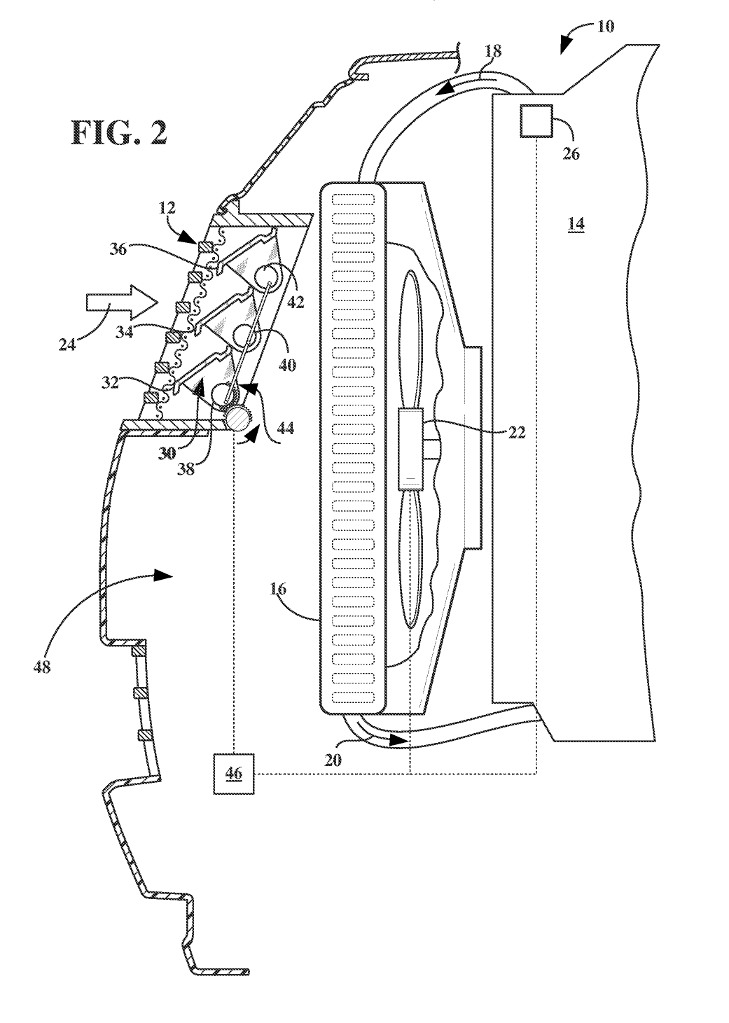

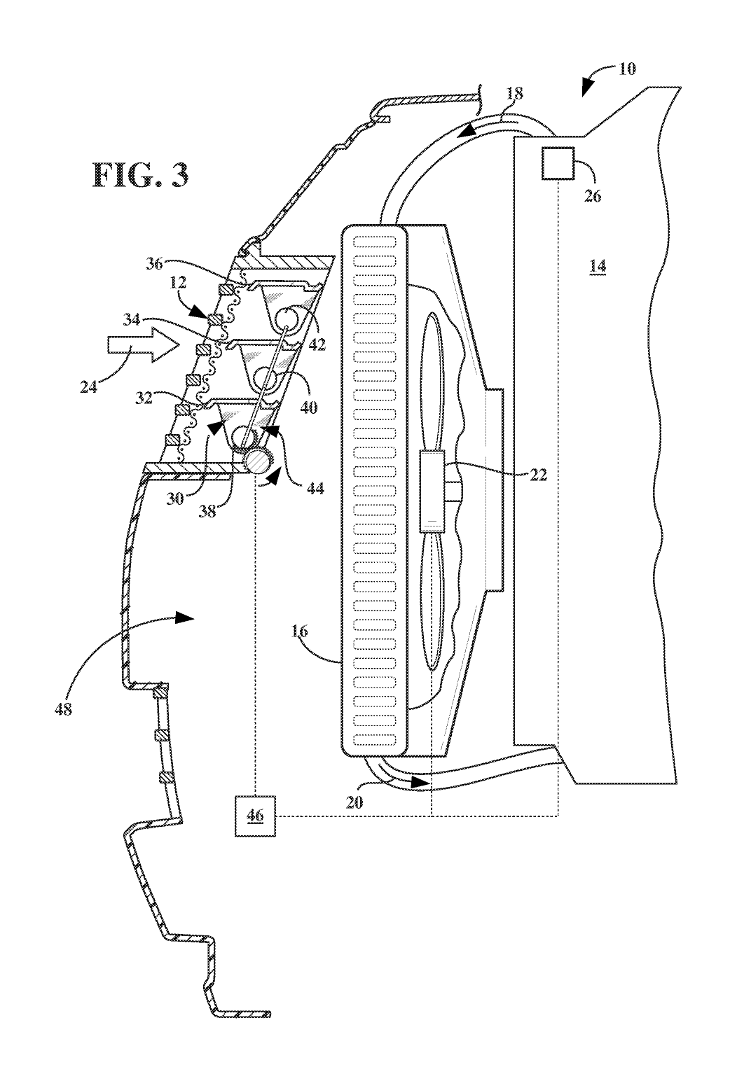

FIGS. 1-3 also depict a rotatable or adjustable shutter 30. The shutter 30 is secured in the vehicle 10 and is adapted to control the airflow 24 through the grille opening 12. As shown, the shutter 30 is positioned behind, and immediately adjacent to the grille opening 12 at the front of the vehicle 10. As shown, the shutter 30 is positioned between the grille opening 12 and the heat exchanger 16. The shutter 30 may also be incorporated into and be integral with the grille opening 12. The shutter 30 includes a plurality of louvers, herein shown as having three individual louver elements 32, 34, and 36, but the number of louvers may either be fewer or greater. Each louver 32, 34, and 36 is configured to rotate about a respective pivot axis 38, 40, and 42 during operation of the shutter 30, thereby effectively controlling the size of the grille opening 12. The shutter 30 is adapted to operate between and inclusive of a fully-closed position or state (as shown in FIG. 1), through an intermediate position (as shown in FIG. 2), and to a fully-opened position (as shown in FIG. 3). When the louver elements 32, 34, and 36 are in any of their open positions, the airflow 24 penetrates the plane of shutter 30 before coming into contact with the heat exchanger 16.

The shutter 30 also includes a mechanism 44 configured to select and lock a desired position for the shutter between and inclusive of fully-opened and fully-closed. The mechanism 44 is configured to cause the louvers 32-36 to rotate in tandem, i.e., substantially in unison, and permitting the shutter 30 to rotate into any of the available positions. The mechanism 44 may be adapted to select and lock either discrete intermediate position(s) of the louvers 32-36, or to infinitely vary position of the louvers between and inclusive of the fully-opened and fully-closed. The mechanism 44 acts to select the desired position for the shutter 30 when activated by any external means, as understood by those skilled in the art, such as an electric motor (not shown). The vehicle 10 also includes a controller 46, which may be an engine controller or a separate control unit, configured to regulate the mechanism 44 for selecting the desired position of the shutter 30. The controller 46 may also be configured to operate the fan 22, if the fan is electrically driven, and a thermostat (not shown) that is configured to regulate the circulation of coolant, as understood by those skilled in the art.

The controller 46 is programmed to regulate the mechanism 44 according to the load on the engine 14 and, correspondingly, to the temperature of the coolant sensed by the sensor 26. The temperature of the high-temperature coolant 18 is increased due to the heat produced by the engine 14 under load. As known by those skilled in the art, a load on the engine is typically dependent on operating conditions imposed on the vehicle 10, such as going up a hill and/or pulling a trailer. The load on the engine 14 generally drives up internal temperature of the engine, which in turn necessitates cooling of the engine for desired performance and reliability. Prior to exiting the engine 14, coolant is routed inside the engine in order to most effectively remove heat from critical engine components, such as bearings (not shown, but known by those skilled in the art). Typically, the coolant is continuously circulated by a fluid pump (not shown) between the engine 14 and the heat exchanger 16.

When the shutter 30 is fully-closed, as depicted in FIG. 1, the louvers 32-36 provide blockage of the airflow 24 at the grille opening 12. A fully-closed shutter 30 provides optimized aerodynamics for the vehicle 10 when engine cooling through the grille opening 12 is not required. The shutter 30 may also be regulated by the controller 46 to variably restrict access of the oncoming airflow 24 to the heat exchanger 16, by rotating the louvers 32-36 to an intermediate position, as shown in FIG. 2, where the louvers are partially closed. An appropriate intermediate position of the louvers 32-36 is selected by the controller 46 according to a programmed algorithm to thereby affect the desired cooling of the engine 14. When the shutter 30 is fully-opened, as shown in FIG. 3, each louver 32-36 is rotated to a position parallel to the airflow 24 seeking to penetrate the shutter system plane. Thus, a fully-opened shutter 30 is configured to permit a generally unfettered passage of such a stream of air through the louver plane of the shutter 30.

The grille opening 12, the heat exchanger 16, the sensor 26, the shutter 30, and the controller 46 are each included in a system 48 for controlling operation of the fan 22. During operation of the system 48, the fan 22 is maintained in an off state below a predetermined duty-cycle value of the fan. The term “duty-cycle” is defined herein as a percentage of maximum airflow that the fan is capable of providing to cool the powertrain of the vehicle 10. The duty-cycle value of the fan 22 is established based on the loads seen by the powertrain and by the loads seen by a Heating, Ventilation and Air Conditioning (HVAC) system (not shown) of the vehicle 10. The predetermined duty-cycle value is additionally associated with a threshold vehicle speed, wherein the threshold vehicle speed is determined in relation to the load on the engine 14. The predetermined duty-cycle for the fan 22 is typically established empirically during testing and development of vehicle 10 and is programmed into the controller 46 for regulating the fan. For example, and without limitation, the threshold vehicle speed may be set at 35 miles per hour (mph), at which speed the duty-cycle of the fan 22 may be set at 30%. According to the duty-cycle, the speed of the fan 22 is increased to generate a higher percentage of the maximum airflow upon the vehicle 10 reaching the threshold speed.

The controller 46 monitors and controls the operation of the fan 22 based on the duty-cycle for cooling the powertrain of the vehicle 10. Accordingly, based on the established duty-cycle, the fan 22 is controlled to below a predetermined fan speed to provide a lower percentage of the maximum airflow below the threshold speed of the vehicle 10. Hence, the operation of the fan 22 is characterized by an established duty-cycle programmed into the controller 46 and the predetermined speed of the fan is selected according to the duty-cycle. Accordingly, the fan 22 may be entirely off below the exemplary predetermined 30% duty-cycle, and may then be turned on above 30%, for example at 31% of the fan duty-cycle. Alongside the operation of the fan 22 below the predetermined speed, the controller 46 maintains the shutter 30 in the fully-closed position. Before the predetermined speed of the fan 22 is selected, the controller 46 selects a non fully-closed position of the shutter 30 to admit a controlled amount of the airflow 24 through the grille opening 12, for example at 30% of the fan duty-cycle.

Such selection of the non fully-closed position of the shutter 30 prior to the selection of the predetermined speed of the fan 22 assures that the fan will not attempt to deliver a volume of the airflow 24 that the fully-closed shutter 30 is incapable of supporting. The non fully-closed position of the shutter 30 may include any of the intermediate positions above the fully-closed position that is shown in FIG. 1, as well as the fully-opened position that is shown in FIG. 3. The controller 46 is further adapted to select the predetermined speed for the fan 22, such as actually turning the fan on, following the shutter 30 having been placed in the non fully-closed position. Hence, the duty-cycle of the fan 22 drives the opening of the shutter 30.

In a moving vehicle 10, the airflow 24 at ambient temperature and traveling at a certain velocity with respect to the vehicle, penetrates the vehicle's grille opening 12. The airflow 24 that moves relative to the vehicle 10 traveling above the threshold vehicle speed generates a significant positive air pressure at grille opening 12, and is thus termed “RAM airflow”. In the vehicle 10 traveling at or below the threshold speed, including when the vehicle is stationary, the airflow 24 at ambient temperature and traveling at a certain low velocity with respect to the vehicle, penetrates the vehicle's grille opening 12. The airflow 24 that moves relative to the vehicle 10 traveling below the threshold speed generates a minimal positive pressure at grille opening 12. Therefore, unless the load on the powertrain of the vehicle 10 requires otherwise, the shutter 22 may be maintained in the fully-opened position.

Above the threshold vehicle speed, the airflow 24 at ambient temperature and traveling at a certain velocity with respect to the vehicle 10 generates some measure of RAM airflow at the grille opening 12. Although in a moving vehicle 10 the airflow 24 generates some positive pressure at the grill opening 12, at vehicle speeds above the threshold speed coupled with increased vehicle loads, the velocity of airflow 24 may be insufficient to generate sufficient RAM airflow to cool the engine 14. Such may be the case even when the shutter 30 is fully-opened and the grille opening 12 is unrestricted, because vehicle loads increase significantly at higher vehicle speeds, especially during warmer, summer temperatures. Accordingly, in the vehicle 10 traveling above the threshold speed, when the fan 22 is operating at or above the second predetermined speed, a fully-opened position may be selected for the shutter 30 to aid powertrain cooling.

Ambient temperatures near and below freezing may present additional considerations for cooling of the powertrain in the vehicle 10. When the ambient temperature is below a predetermined value, i.e., near or below freezing, sufficient cooling of the engine 14 may be achieved with the grille opening 12 either in the partially restricted or in the fully blocked state. At the same time, the louvers 32-36 and the mechanism 44 may freeze and become jammed at such low temperatures. Therefore, in order to prevent jamming of the shutter 30 in some unwanted position, when the ambient temperature is below the predetermined value, an appropriate predetermined position of the shutter 30 may be selected and locked without regard to vehicle speed and load. The grille opening 12 may be placed in any position between and inclusive of the fully-opened and the fully-restricted states via the predetermined position of the shutter 30 depending on the cooling requirements of the powertrain of the vehicle 10.

The predetermined locked position or a number of discrete locked positions of the shutter 30 that would still permit sufficient cooling of the powertrain near and below freezing ambient temperatures may be established empirically during testing and development of the vehicle 10. The controller 46 may be employed to monitor the ambient temperature via a temperature sensor (not shown) and regulate and lock the position of the shutter 30 via the mechanism 44 in response to the ambient temperature being below the predetermined value. While any of the discrete predetermined locked positions of the shutter 30 are selected, the fan 22 may be operated either in an on state or an off state depending on the powertrain load and the established fan duty-cycle. Full control over the selectable positions of the shutter 30 may then be returned when the ambient temperature again rises above the predetermined value.

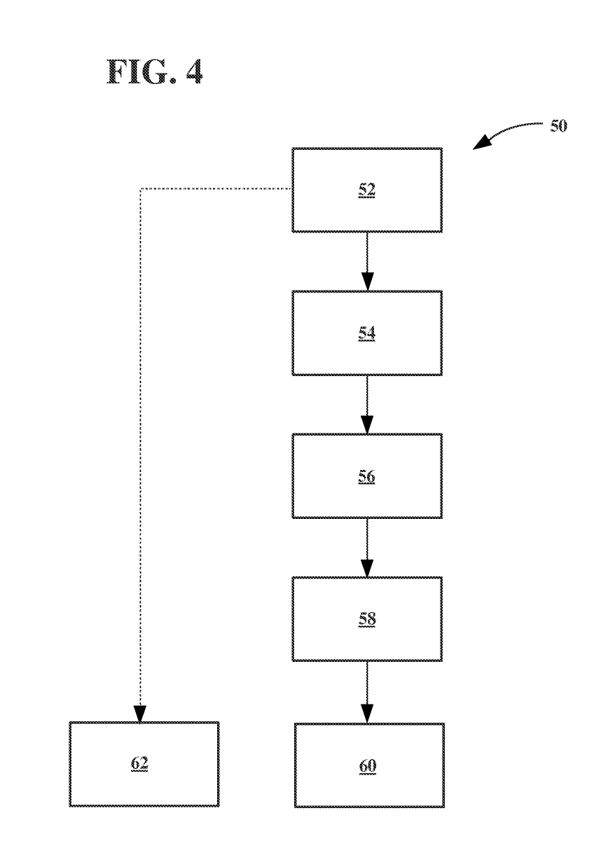

FIG. 4 depicts a method 50 for increasing an operating efficiency of a powertrain by controlling the airflow 24 through the grille opening 12 in the vehicle 10 via the shutter 30, as described above with respect to FIGS. 1-3. The method commences in frame 52 and then proceeds to frame 54 where it includes monitoring the operation of the fan 22 via the controller 46. Following frame 54, the method advances to frame 56. In frame 56, the method includes maintaining the fully-closed position of shutter 30, as shown in FIG. 1, when the speed of the fan 22 is below the predetermined speed.

Following frame 56, the method proceeds to frame 58, where it includes selecting the non fully-closed position of the shutter 30 by the controller 46 before the predetermined speed of the fan 22 is selected. As described above, the non fully-closed position of the shutter 30 may include any position above the fully-closed position, as shown in FIG. 1, and up to and including the fully-opened position shown in FIG. 3. After frame 58, the method progresses to frame 60, where the method includes selecting the predetermined speed of the fan 22 after the non fully-closed position of the shutter 30 has been selected.

Additionally, the method may proceed directly from frame 52 to frame 62, where the method includes monitoring the ambient temperature. In frame 62, regardless of vehicle speed, the method includes using the controller 46 for selecting and locking a predetermined position for the shutter 30, which may include any of the positions shown in FIGS. 1-3, in response to the ambient temperature being below a predetermined value. Additionally, in the optional frame 62 the method includes selecting an on state or speed of the fan 22, or the off state of the fan 22 when the predetermined locked position of the shutter 30 is selected. The method may thus completely close off access of the airflow 24 to the heat exchanger 16 by regulating the mechanism 44 to select and lock the shutter 30 in the fully-closed position.

While the best modes for carrying out the invention have been described in detail, those familiar with the art to which this invention relates will recognize various alternative designs and embodiments for practicing the invention within the scope of the appended claims.

1. A method of controlling operation of an adjustable shutter configured to be operated between and inclusive of fully-closed and fully-opened positions for cooling a powertrain in a vehicle having a grille opening, the method comprising:
monitoring operation of a fan capable of being driven at a selectable speed for cooling the powertrain, wherein the fan is arranged relative to the grille opening and proximate the shutter;
maintaining the fully-closed position of the shutter when the speed of the fan is below a predetermined speed;
selecting a non fully-closed position of the shutter before the predetermined speed of the fan is selected; and
selecting the predetermined speed of the fan after the non fully-closed position of the shutter has been selected.

2. The method of claim 1, wherein the non fully-closed position of the shutter is the fully-opened position.

3. The method of claim 2, wherein each of said maintaining the fully-closed position of the shutter, selecting a non fully-closed position of the shutter, and selecting the predetermined speed of the fan is accomplished by a controller.

4. The method of claim 3, wherein the operation of the fan is characterized by an established duty-cycle programmed into the controller and the predetermined speed of the fan is selected according to the duty-cycle.

5. The method of claim 4, wherein the powertrain includes an internal combustion engine and the duty-cycle of the fan is established according to a load on the engine.

6. The method of claim 5, wherein the vehicle includes a heat exchanger and a fluid circulated through the heat exchanger such that the engine is cooled by the fluid and a sensor configured to sense a temperature of the fluid, and wherein the duty-cycle of the fan is additionally established according to the sensed temperature of the fluid.

7. The method of claim 1, wherein the shutter is arranged one of integral to the grille opening and adjacent to the grille opening.

8. The method of claim 1, further comprising monitoring the ambient temperature and selecting and locking a predetermined position for the shutter in response to the ambient temperature being below a predetermined value, and selecting one of an on state and an off state for the fan when the predetermined locked position of the shutter is selected.

9. A system for controlling operation of an adjustable shutter configured to be operated between and inclusive of fully-closed and fully-opened positions for cooling a powertrain in a vehicle, the system comprising:
a grille opening located on the vehicle relative to the fan;
a fan capable of being driven at a selectable speed for cooling the powertrain, wherein the fan is arranged relative to the grille opening and proximate the shutter; and
a controller adapted to:
monitor operation of the fan capable of being driven at a selectable speed for cooling the powertrain, wherein the fan is arranged relative to the grille opening and proximate the shutter;
maintain the fully-closed position of the shutter when the speed of the fan is below a first predetermined speed;
select a non fully-closed position of the shutter before the predetermined speed of the fan is selected; and
select the predetermined speed of the fan after the non fully-closed position of the shutter has been selected.

10. The system of claim 9, wherein the non fully-closed position of the shutter is the fully-opened position.

11. The system of claim 9, wherein the operation of the fan is characterized by an established duty-cycle programmed into the controller and the predetermined speed of the fan is selected according to the duty-cycle.

12. The system of claim 9, wherein the powertrain includes an internal combustion engine and the duty-cycle of the fan is established according to a load on the engine.

13. The system of claim 12, further comprising a heat exchanger and a fluid circulated through the heat exchanger such that the engine is cooled by the fluid and a sensor configured to sense a temperature of the fluid, and wherein the duty-cycle of the fan is additionally established according to the sensed temperature of the fluid.

14. The system of claim 10, wherein the shutter is arranged one of integral to the grille opening and adjacent to the grille opening.

15. The system of claim 10, wherein the controller is further adapted to monitor the ambient temperature and select and lock a predetermined position of the shutter in response to the ambient temperature being below a predetermined value, and to select one of an on state and an off state for the fan when the predetermined locked position of the shutter is selected.

16. A vehicle comprising:
an internal combustion engine cooled by a fluid;
a fan capable of being driven at a selectable speed for cooling the engine:
a grille opening located on the vehicle relative to the fan and adapted for receiving an airflow;
a heat exchanger positioned proximate the grill opening and the fan for circulating the fluid though the engine;
an adjustable shutter arranged relative to the grille opening and proximate the fan, wherein the shutter is configured to be operated between and inclusive of fully-closed and fully-opened positions to selectively restrict and unrestrict the grille opening; and
a controller adapted to:
monitor operation of the fan;
maintain the fully-closed position of the shutter when the speed of the fan is below a predetermined speed;
select a non fully-closed position of the shutter before the predetermined speed of the fan is selected; and
select the predetermined speed of the fan after the non fully-closed position of the shutter has been selected.

17. The vehicle of claim 16, wherein the non fully-closed position of the shutter is the fully-opened position.

18. The vehicle of claim 16, wherein the operation of the fan is characterized by an established duty-cycle programmed into the controller and the predetermined speed of the fan is selected according to the duty-cycle.

19. The vehicle of claim 17, wherein the controller is further adapted to monitor the ambient temperature and select and lock a predetermined position of the shutter in response to the ambient temperature being below a predetermined value, and to select one of an on state and an off state for the fan when the predetermined locked position of the shutter is selected.
